(19) United States
(12) Patent Application Publication
(10) Pub. No.: US 2006/0261088 A1
(43) Pub. Date: Nov. 23, 2006

(54) Container systems for beverages and other fluids, and associated methods of manufacture and use

(75) Inventor: Tola R. Chin, Las Vegas, NV (US)

Correspondence Address: PERKINS COIE LLP;PATENT-SEA, P.O. BOX 1247, SEATTLE, WA, 98111-1247, US

(73) Assignee: Qin's, Inc.

(21) Appl. No.: 11/295,848

(22) Filed: Dec. 7, 2005

Related U.S. Application Data
(60) Provisional application No. 60/683,463, filed on May 20, 2005.

(51) Int. Cl. B67D 5/60; B67D 5/06

(52) U.S. Cl. 222/131; 222/183; 222/185.1

(57) ABSTRACT

Fluid container systems and associated methods of manufacture and use are disclosed herein. A fluid container system configured in accordance with one embodiment of the invention includes an inner vessel and an outer structure. The inner vessel can be fixedly attached to the outer structure to define an enclosed volume therebetween. The enclosed volume can be at least partially evacuated and sealed. The enclosed volume can extend continuously from a first interior surface of a first side portion of the outer structure to a second interior surface of a second side portion of the outer structure. In certain embodiments, the first and second side portions can extend along different planes. In another aspect of the invention the inner vessel can include a sump positioned proximate to an outlet device located in a side portion of the vessel.

### CROSS-REFERENCE TO RELATED APPLICATION

This application claims the benefit of, and priority to, U.S. Provisional Patent Application Ser. No. 60/683,463, filed May 20, 2005, and entitled “Container Systems for Beverages and Other Fluids, and Associated Methods of Manufacture and Use,” which is incorporated herein in its entirety by reference.

### TECHNICAL FIELD

The following disclosure relates generally to container systems for beverages and other fluids, and associated methods of manufacture and use.

### BACKGROUND

Many beverage dispensers are insulated so that they can store a beverage within a desired temperature range for an extended period of time. For example, many beverage dispensers are cylindrical in shape and include vacuum linings in their cylindrical walls to reduce heat transfer between the beverage and the surrounding environment. These vacuum linings generally include sealed areas that are evacuated to a pressure lower than ambient pressure. Because of the reduced pressure, the molecular density of the air is low and heat transfer across the region is inefficient. As a result, the beverage remains near its original temperature for an extended period of time as compared to a beverage that is carried in a dispenser using other types of insulation materials (e.g., fibrous insulation materials). The cylindrical shape of these dispensers aids in providing the structural integrity needed to maintain a vacuum and simplifies the production process required to create the evacuated region.

Rectangular or box style dispensers typically use insulation materials to insulate the beverages they contain. As a result, rectangular dispensers are generally less effective at maintaining the temperature of a beverage within a desired range for an extended period of time. Because rectangular dispensers are generally less effective at maintaining a desired temperature, many use a heater or warming element to keep beverages hot.

Another problem associated with conventional beverage dispensers (e.g., vacuum insulated or otherwise) is that the temperature of a portion of the dispensed beverage (e.g., a serving of the beverage) can vary significantly from the temperature of the beverage stored in the dispenser. This can be especially true when an extended period of time elapses between dispensing beverage servings.

### SUMMARY

The present invention is directed generally toward fluid container systems and associated methods of manufacture and use. One aspect of the invention is directed toward a container system that includes an outer structure having a first side portion extending along a first plane and a second side portion extending along a second plane different than the first plane. The container system can further include an inner vessel configured to carry fluid. The inner vessel can be fixedly attached to the outer structure to define an enclosed volume therebetween. The enclosed volume can be at least partially evacuated to a pressure less than an external pressure. In various embodiments, the container system can have a rectangular or other polyhedron shape.

In another aspect of the invention, a container system can include an outer structure having a first side portion positioned adjacent to a second side portion. The first side portion can be at least approximately aligned with a first plane and the second side portion can be at least approximately aligned with a second plane different than the first plane. The container system can further include an inner vessel having a third side portion positioned adjacent to a fourth side portion. The third side portion can be offset from the first side portion to define a first evacuated region therebetween. The fourth side portion can be offset from the second side portion to define a second evacuated region therebetween. The container system can additionally include an open passage extending from the first evacuated region to the second evacuated region.

In yet another aspect of the invention, a method for making a container system can include providing an outer structure and an inner vessel. The outer structure can include a first side portion extending along a first plane and a second side portion extending along a second plane different than the first plane. The inner vessel can be configured to carry fluid. The method can further include positioning the inner vessel within the outer structure, and fixedly attaching the inner vessel to the outer structure to define an enclosed volume extending at least between the inner vessel and the first and second side portions of the outer structure. The method can additionally include at least partially evacuating the enclosed volume.

### BRIEF DESCRIPTION OF THE DRAWINGS

FIG. 1 is an isometric view of a vacuum insulated container system configured in accordance with an embodiment of the invention.

FIG. 2 is a partially exploded, isometric cross-sectional view of the vacuum insulated container system shown in FIG. 1.

FIG. 3 is a partially schematic, top cross-sectional view of the vacuum insulated container system shown in FIG. 1.

FIG. 4 is an isometric view of an inner vessel of the vacuum insulated container system shown in FIG. 1.

FIG. 5 is an isometric view of an outer structure of the vacuum insulated container system shown in FIG. 1.

FIG. 6 is an isometric view illustrating a method of using a vacuum insulated container system in accordance with an embodiment of the invention.

FIG. 7 is a partially schematic cross-sectional view of a container system configured in accordance with another embodiment of the invention.

### DETAILED DESCRIPTION

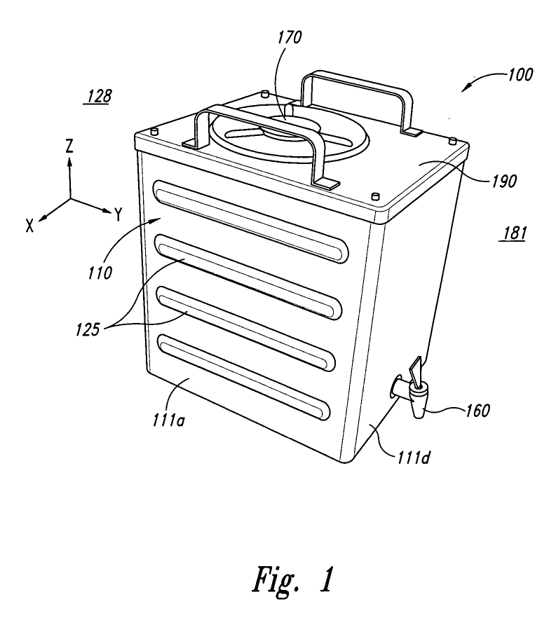

The present disclosure describes fluid container systems and associated methods of manufacture and use. Several specific details of the invention are set forth in the following description and in FIGS. 1-7 to provide a thorough understanding of certain embodiments of the invention. One skilled in the art, however, will understand that the present invention may have additional embodiments, and that other embodiments of the invention may be practiced without several of the specific features described below.

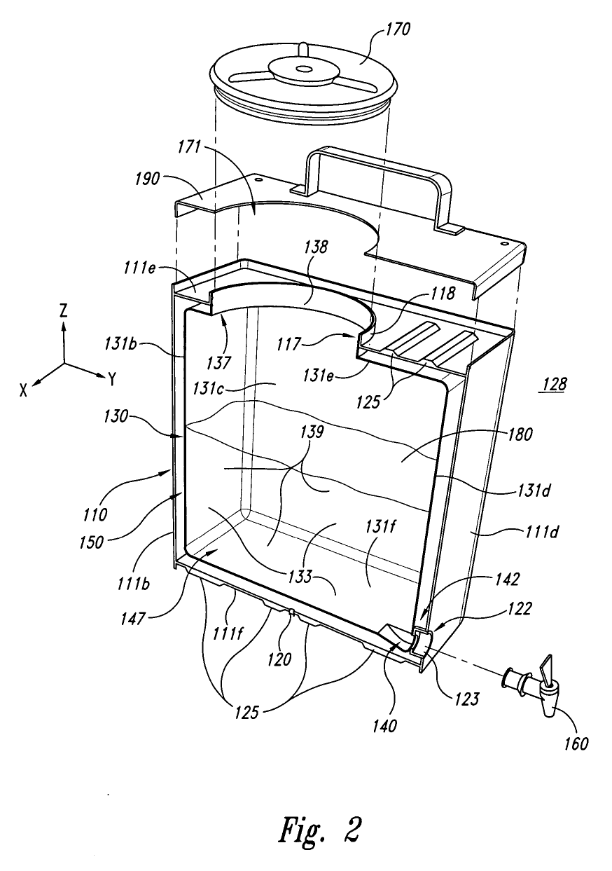

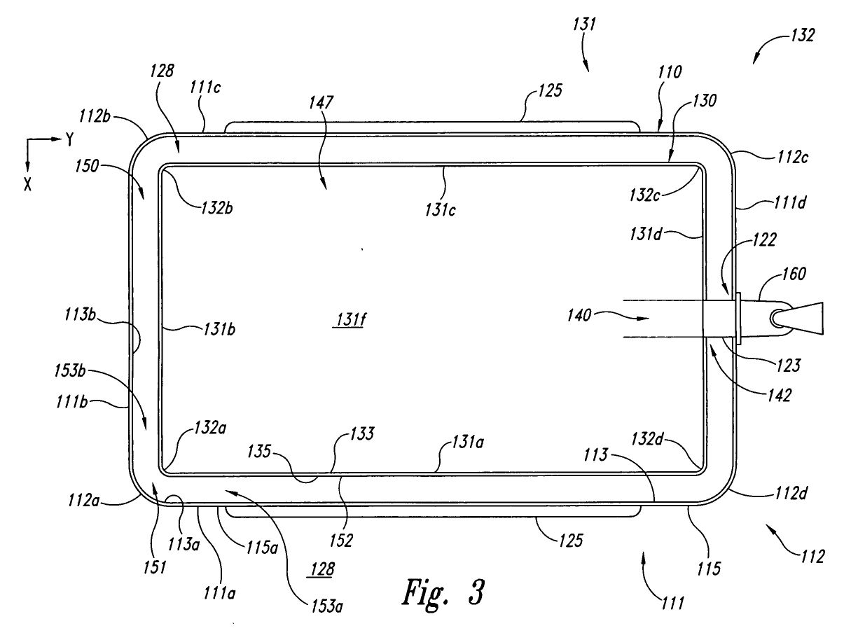

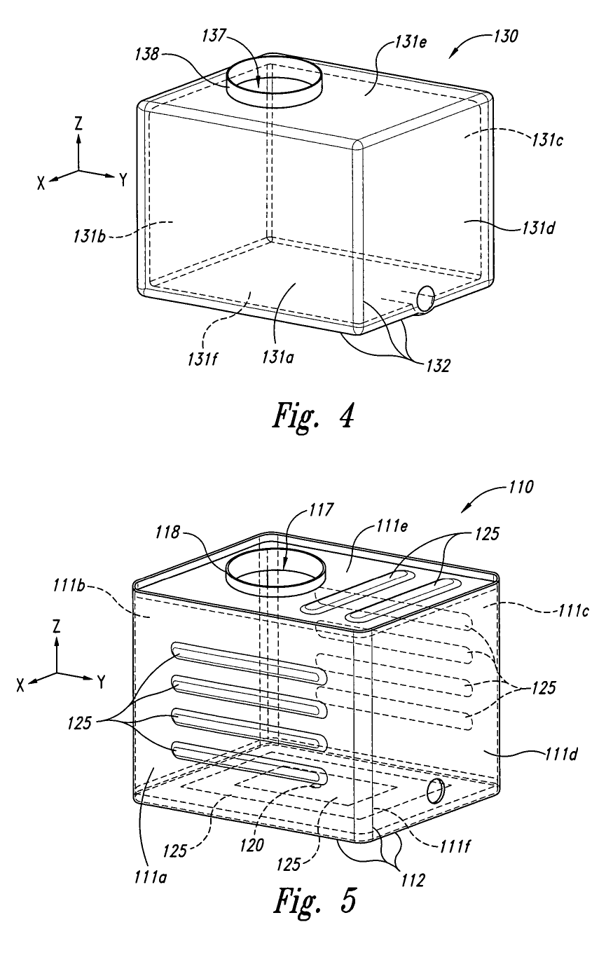

FIG. 1 is an isometric illustration of a vacuum insulated container system 100 (e.g., a vacuum insulated beverage container) configured in accordance with an embodiment of the invention. FIG. 2 is an isometric cross-sectional illustration of the container system 100 shown in FIG. 1. FIG. 3 is a partially schematic, top cross-sectional view of the container system 100 shown in FIG. 1. FIG. 4 is an isometric illustration of an inner vessel 130 of the container system 100 shown in FIG. 1. FIG. 5 is an isometric illustration of an outer structure 110 of the container system 100 shown in FIG. 1.

In the illustrated embodiment, the container system 100 includes an outer structure 110 having multiple outer portions 111 extending in different planes. The outer portions 111 can include a first outer side portion 111a, a second outer side portion 111b, a third outer side portion 111c, a fourth outer side portion 111d, an outer top portion 111e, and an outer bottom portion 111f. The first, second, third, and fourth outer side portions 111a-d extend between the outer top portion 111e and the outer bottom portion 111f. The outer portions 111 are generally planar and can be joined together to form a polyhedron shape (e.g., a rectangular parallelepiped shape). In the illustrated embodiment, the outer top portion 111e includes an aperture or first inlet 117 surrounded by a first inlet flange 118, and the fourth outer side portion 111d includes an aperture or first outlet 122. Other components can be coupled to the outer structure 110, for example, in the illustrated embodiment a cover 190 having handles is coupled to the outer top portion 111e to facilitate the handling of the container system 100.

Referring primarily to FIGS. 1 and 2, the inner vessel 130 is configured to carry a fluid 180 (e.g., a beverage, such as coffee, tea, etc.) and includes multiple inner portions 131 extending in different planes. The inner portions 131 include a first inner side portion 131a, a second inner side portion 131b, a third inner side portion 131c, a fourth inner side portion 131d, an inner top portion 131e, and an inner bottom portion 131f. The first, second, third, and fourth inner side portions 131a-d extend between the inner top portion 131e and the inner bottom portion 131f. The inner portions 131 are generally planar and can be joined together to form a polyhedron shape (e.g., a rectangular parallelepiped shape) that is similar to the shape of the outer structure 110, but smaller in size. In the illustrated embodiment, the inner top portion 131e includes an aperture or second inlet 137 surrounded by a second inlet flange 138, and the fourth inner side portion 131d includes an aperture or second outlet 142. In the illustrated embodiment, interior surface(s) of the inner vessel 130 are coated with an antibacterial coating 139 (e.g., Teflon®). In other embodiments, the interior surfaces of the inner vessel 130 can have other coatings or, alternatively, the coating can be omitted.

In the illustrated embodiment, the inner vessel 130 is fixedly attached to the outer structure 110 to form an enclosed volume 150 extending between the inner vessel 130 and outer structure 110. For example, the inner vessel 130 can be placed within the outer structure 110 (e.g., the outer structure can be built around the inner vessel) to position the second inlet flange 138 of the inner vessel 130 inside the first inlet flange 118 of the outer structure 110. The first and second inlet flanges 118, 138 can then be joined or attached together (e.g., the first inlet flange 118 and the second inlet flange 138 can be welded together). Additionally, the first outlet 122 of the outer structure 110 can be attached or coupled to the second outlet 142 of the inner vessel 130 via an outlet flange, hub fitting, or bushing 123 sealably positioned within and/or attached to the first and second outlets 122, 142 (e.g., via resistance welding) to seal the enclosed volume 150 from the first and second outlets 122, 142. Accordingly, the enclosed volume 150 extends along at least a portion of each interior surface 113 of the outer structure 110. As described in greater detail below, in one embodiment the enclosed volume 150 can be evacuated to insulate the fluid 180 carried by the inner vessel 130.

Because of the manner in which the inner vessel 130 is attached to the outer structure 110, the enclosed volume 150 can be at least approximately sealed, with the exception of an evacuation aperture 120 (shown in FIG. 2) in the outer structure 110. The evacuation aperture 120 can initially be open. To evacuate the enclosed volume 150, the container system 100 can be placed in a high temperature/low pressure environment. The evacuation aperture 120 can then be sealed to prevent a loss of vacuum when the container system 100 is taken out of the high temperature/low pressure environment. For example, the container system 100 can be placed in a vacuum room with an ambient pressure of 10³ torr and a temperature of 1100 degrees centigrade. The evacuation aperture 120 can then be sealed by melting a ball of material (e.g., a ball of metal or plastic material) over the evacuation aperture 120 and/or over a mesh extending across the evacuation aperture 120. The container system 100 can then be removed from the vacuum room. Because the enclosed volume 150 is at least approximately sealed, a lower than ambient pressure condition can be maintained in the enclosed volume 150 for an extended period of time to provide favorable insulation characteristics.

To further aid in insulating the fluid 180 carried by the inner vessel 130, an insulation material 152 can be located within the enclosed volume 150. For example, in the illustrated embodiment portions of the exterior surface 135 of the inner portions 131 of the inner vessel 130 are coated with an insulation material 152 (e.g., foam, copper, or copper foil). In other embodiments, the portions of the inner surface of the outer portions 111 of the outer structure 110 can be coated with an insulating material 152 and/or an insulating material 152 can be placed in the enclosed volume 150 without being attached to the inner vessel 130 or outer structure 110 (e.g., a fibrous material can be placed in the enclosed volume 150). In still other embodiments, there is no insulation material 152 in the enclosed volume 150.

The container system 100 can also include stiffeners 125 to increase structural integrity of the container system 100. For example, one or more of the outer portions 111 of the outer structure 110 and/or the inner portions 131 of the inner vessel 130 can include stiffeners 125 to prevent the respective outer and/or inner portions 111, 131 from being deformed by the pressure differential between the enclosed volume 150 and the external environment. The stiffeners 125 can include added material attached to the respective outer and/or inner portions 111, 131 and/or ribs formed in the material used to make the outer and/or inner portions 111, 131. Additionally, the stiffeners 125 can include various shapes and/or configurations.

For example, in the illustrated embodiment, the first outer side portion 111a, the third outer side portion 111c, and the outer top portion 111e include stiffeners 125 on their exterior surfaces. Additionally, the outer bottom portion 111f includes two stiffeners 125 that are rectangular in shape. Although the outer structure 110 of the illustrated embodiment is shown having stiffeners 125, it is understood that in other embodiments other portions of the container system 100 can have stiffeners 125. For example, in certain embodiments the inner vessel 130 can include stiffener(s) 125. It is also understood that although the stiffeners 125 can vary the shape or configuration of the outer and/or inner portion(s) 111, 131 to a small degree, the stiffener(s) 125 can be added to the outer and/or inner portion(s) 111, 131 without changing their generally planar characteristics and/or without affecting the general shape of the container system 100.

In certain embodiments, the outer corner sections 112 where the outer portions 111 of the outer structure 110 are joined and/or the inner corners 132 where the inner portions 131 of the inner vessel 130 are joined can also serve to reinforce the container system 100. For example, in the illustrated embodiment the inner side portions 131a-d are joined with rounded corner sections 132. The rounded corner sections 132 can reinforce the inner vessel 130 (e.g., strengthen and/or increase the rigidity of the inner vessel 130).

In the illustrated embodiment, the outer structure includes both rounded and sharp outer corner sections 112, both of which can provide reinforcement to the vessel. For example, the first, second, third, and fourth outer side portions 111a-d can be joined by rounded corner sections 112. The inner vessel 130 (as shown in FIG. 4) can then be placed in (e.g., surrounded by) the first, second, third, and fourth outer side portions 111a-d. The peripheral edges of the outer top portion 111e and outer bottom portion 111f can be folded or bent to run parallel to the first, second, third, and fourth outer side portions 111a-d. The outer top portion 111e and the outer bottom portion 111f can then be coupled or joined to the first-fourth outer side portions 111a-d (e.g., via roller welding and/or resistance welding) to create thick sharp corner sections 112, which can reinforce the outer structure 110. Regardless of the types of corners used to join the inner portions 131 of the inner vessel 130 and/or the outer portions 111 of the outer structure 110, it will be understood that the outer and inner portions 111, 131 in the illustrated embodiments are still generally planar and that the inner vessel 130 and outer structure 110 still generally have polyhedron shapes.

The outer and inner corner sections 112, 132 can also create passage(s) between various evacuated regions of the enclosed volume 150. For example, as illustrated in FIG. 3, four outer corner sections 112 are shown as a first outer corner section 112a, a second outer corner section 112b, a third outer corner section 112c, and a fourth outer corner section 112d joining the first, second, third, and fourth outer side portions 111a-d. Similarly, four inner corner sections 132 are shown as a first inner corner section 132a, a second inner corner section 132b, a third inner corner section 132c, and a fourth inner corner section 132d joining the first, second, third, and fourth inner sides portions 131a-d. The first, second, third, and fourth outer side portions 111a-d can be offset (e.g., by five millimeters) from the first, second, third, and fourth inner side portions 131a-d to form part of the enclosed volume 150.

A first evacuated region 153a includes a portion of the enclosed volume 150 between the first outer side portion 111a and the first inner side portion 131a. A second evacuated region 153b includes a portion of the enclosed volume between the second outer side portion 111b and the second inner side portion 131b. The first and second evacuated regions 153a, 153b are connected by a passage 151 which is created by the first and second outer side portions 111a-b, the first and second inner side portions 131a-b, the first outer corner section 112a, and the first inner corner section 132a. In the illustrated embodiment, the passage 151 extends from the outer bottom portion 111f to the outer top portion 111e. In other embodiments, the passage 151 can have other arrangements including being formed by other components and/or only partially extending from the outer bottom portion 111f to the outer top portion 111e.

As discussed above with reference primarily to FIGS. 1 and 2, the first inlet 117 in the outer structure 110 is aligned with the second inlet 137 in the inner vessel 130 and the first and second inlet flanges 118, 138 are joined or fixedly attached to one another. The first and second inlets 117, 137 from an inlet passageway 171 from exterior 128 of the outer structure 110 into the interior 147 of the inner vessel 130. An inlet device 170 can be positioned proximate to the first and second inlets 117, 137 to obstruct the inlet passageway 171. In certain embodiments, the inlet device 170 releasably seals the inlet passageway 171, but is removable to allow the inner vessel 130 to be filled with fluid 180. In other embodiments, the inlet device 170 only partially seals the inlet passageway 171 and/or is configured to allow fluid to enter the inner vessel 130 without removal of the inlet device 170. In some embodiments, the inlet device 170 has insulating characteristics.

An outlet device 160 (e.g., a sealable outlet or a spigot) can be positioned to allow fluid 180 to be removed from the inner vessel 130. For example, in the illustrated embodiment an outlet device 160 extends from the interior 147 of the vessel 130 through the second outlet 142 in a fourth inner side portion 131d, and through the first outlet 122 in the fourth outer side portion 111d. In certain embodiments, the outlet device 160 can be configured to have an open and closed position. In the open position, fluid 180 from the interior 147 of the inner vessel 130 can flow through the outlet device 160 and in the closed position, fluid 180 can be prevented from flowing though the outlet device 160. Accordingly, the outlet device 160 can provide a convenient way to controllably dispense fluid 180 from the inner vessel 130.

To aid in removing fluid 180 from the interior 147 of the inner vessel 130, the inner vessel 130 can also includes a sump 140 located proximate (e.g., immediately adjacent) to the outlet device 160. In the illustrated embodiment, the sump 140 includes a depression or sloping portion of the inner bottom portion 131f that slopes toward the outlet device 160. Because the sump 140 is the lowest part of the vessel bottom when the container system 100 is in an upright position, the fluid 180 collects in the sump 140 and is easily removed through the outlet device 160. Although the sump 140 alters the shape of the inner bottom portion 131f, it is understood that the inner bottom portion 131f in the illustrated embodiment is still generally planar and that the inner vessel 130 still has the same general shape as the outer structure 110.

A feature of some of the embodiments described above is that the container system can include the efficient insulating characteristics associated with vacuum insulated containers, along with the space efficient characteristics of a container system having a polyhedron shape (e.g., a rectangular shape). Additionally, when required, one or more reinforcing segment(s) can be used to insure that the container system can maintain the desired shape by providing additional structural integrity/rigidity. This feature can be especially important when the container system is configured to be inserted in a brewing machine or positioned in an area requiring consistent physical dimensions. An advantage of these features is that a vacuum insulated container system configured in accordance with embodiments of the present invention can have better space efficiency than existing vacuum insulated beverage dispensers.

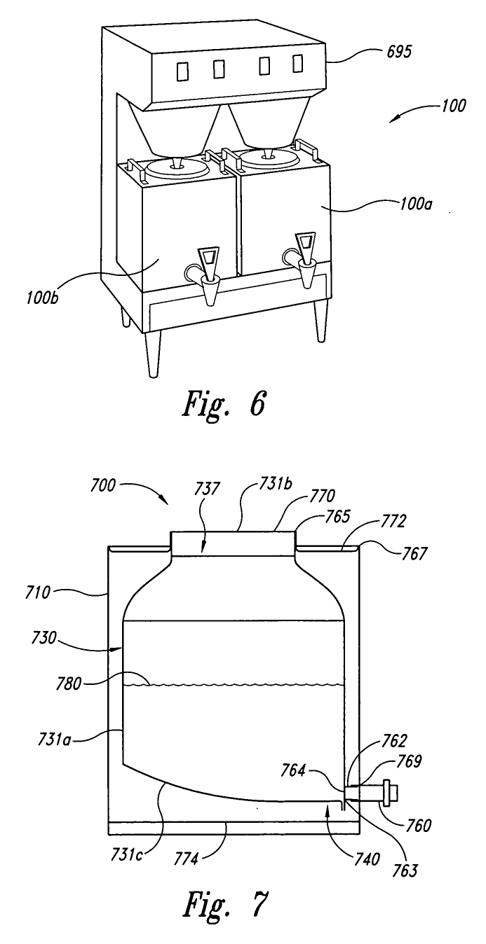

Additionally, as shown in FIG. 6, container systems 100 (e.g., shown as a first container system 100a and a second container system 100b) configured in accordance with some of the above embodiments discussed above can be positioned in, on, or proximate to a brewing machine 695 to receive fluid (e.g., coffee or other beverage) from the brewing machine 695. In certain embodiments, the brewing machine 695 can be configured to interface specifically with space efficient rectangular beverage dispensers. For example, in certain embodiments the brewing machine 695 can include an existing brewing machine (e.g., an existing coffee or tea brewing machine) configured to hold rectangular beverage dispensers that require heating element(s) to maintain a beverage at a desired temperature. Such brewing machines can be obtained from the Wilbur Curtis Company of Montebello, Calif., or the Bunn-O-Matic Corporation of Springfield, Ill. Because container systems configured in accordance with some of the embodiments discussed above can include vacuum insulated characteristics, the heating elements of these existing brewing machines can be turned off and/or disconnected. Accordingly, energy can be saved and operating costs reduced over existing beverage dispensers that require heating elements.

Another feature of some of the embodiments discussed above is that the sump is located proximate to an outlet device on a side of the container system. Because the sump is adjacent to the outlet device and positioned in an insulated area (e.g., surrounded by part of the evacuated enclosed volume), fluid can pass directly to the outlet device without having to transit a long uninsulated passageway, as required with conventional beverage dispensers. An advantage of this feature is that the fluid can be released at the same temperature as the main body of fluid carried by the container system. Additionally, as the fluid level in the container system is lowered, the sump aids in reducing the amount of fluid left in the container system.

In other embodiments, the container system 100, shown in FIGS. 1-5, can have other arrangements. For example, in certain embodiments the inner vessel 130 and the outer vessel 110 can have more or fewer side portions, different shapes from those shown in the illustrated embodiments, and/or different shapes from one another. Additionally, in some embodiments, the enclosed volume 150 does not extend along/between all of the side portions 111, 131 as shown in the illustrated embodiments and/or the inner vessel 130 is not completely surrounded by the outer structure 110. For example, in certain embodiments the container system can have one or more open side(s) and/or only a selected number of outer and inner portions 111, 131 are used to form the enclosed volume 150. In other embodiments, the container system 100 can include outer and/or inner portions 111, 131 that are planar and additional outer and/or inner portions 111, 131 that are non-planar. In still further embodiments, the container system has more or fewer inlet passageway(s) 171, inlet device(s) 170, and/or an outlet device(s) 160. In yet other embodiments, the inlet passageway(s) 171, inlet device(s) 170, and/or an outlet device(s) 160 can have other locations and/or configurations. For example, an outlet device can be used to seal the enclosed volume 150 proximate to the first (outer structure) outlet 122 and the second (inner vessel) outlet 142 without additional components (e.g., without an outlet flange, hub fitting, or bushing 123).

In various embodiments, different materials including metal, plastics, and composites can be used to make the inner vessel 130, the outer structure 110 and/or other components of the container system 100. In certain embodiments, the inner vessel 130 and the outer structure 110 are fixedly attached to each other in other manners and/or the portions 111, 131 of the outer structure 110 and inner vessel 131 are joined together in other manners (e.g., multiple side portions can be formed from a single piece of material). In still other embodiments, stiffener(s) 125 are located on other portions of the container system 100 or are not used in the construction of the container system 100. For example, the stiffeners 125 can be located on an interior surface 113 of the outer side portions 111 (instead of on an exterior surface 115 as shown in FIG. 3) and/or on various corners of the container system 100. Although in the illustrated embodiment, a temperature controlled vacuum room was used to evacuate the enclosed volume, in other embodiments other evacuation methods can be used (e.g., a vacuum pump).

In still other embodiments, the sump 140 can be omitted from the container system 100 or, alternatively, the sump 140 can have a different configuration. For example, FIG. 7 is a partially schematic cross-sectional elevation of a container system 700 (e.g., a cylindrical container system) having a sump 740 located adjacent to an outlet device 760 in accordance with another embodiment of the invention. In FIG. 7 an inner vessel 730 (e.g., a cylindrical vessel) includes a side portion 731a, a top portion 731b, and a bottom portion 731c. The top portion 731b includes an inlet 737 and is configured to receive an inlet device 770 (e.g., a screw-on top) that can be positioned to block at least a portion of the inlet 737. The vessel 730 can be carried by an outer structure 710 (e.g., a cylindrical outer structure). The outlet device 760 can be positioned to allow fluid 780 to be removed from the interior of the vessel 730 through the side portion 731a and through the outer structure 710. The bottom portion 731c of the vessel can be sloped so that the sump is located proximate (e.g., immediately adjacent) to the outlet device 760. Because the sump is the lowest part of the bottom portion 731c when the container system is in an upright position, as shown in FIG. 7, the sump facilitates removal of fluid from the vessel 730 through the outlet device 760. In one embodiment, the sump 740 can include a single point on the bottom portion 731c of the vessel 710. In other embodiments, the outer structure 710 can be omitted. The sump 740 arrangement shown in FIG. 7 is equally applicable to container systems having other shapes (e.g., rectangular), insulated container systems, or any of the container systems discussed above with reference to FIGS. 1-5.

The container system 700 can be manufactured in one embodiment as follows. The bottom portion 731c of the inner vessel 730 is welded to the side portion 731a. Next, a tie-in tube 762 is welded around an opening 764 in the side portion 731a at a first joint 763. Next, the inner vessel 730 is positioned inside of the outer structure 710 as shown in FIG. 7, and the outlet device 760 is inserted through a sidewall of the outer structure 710 and mated to the tie-in tube 762. A cover 772 is then welded to the top portion 731b of the inner vessel 730 along a second joint 765. The cover 772 is then pressed against the outer structure 710 and welded to the outer structure 710 along a third joint 767. The outlet device 760 is then welded to the outer structure 710 along a fourth joint 769. A base 774 can then be assembled to the bottom portion of the outer structure 710.

From the foregoing, it will be appreciated that specific embodiments of the invention have been described herein for purposes of illustration, but that various modifications may be made without deviating from the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/we claim:

1. A vacuum insulated container system, comprising:
an outer structure having a first side portion positioned adjacent to a second side portion, the first side portion extending along a first plane and the second side portion extending along a second plane different than the first plane; and
an inner vessel configured to carry fluid, the inner vessel being fixedly attached to the outer structure to define an enclosed volume extending at least between the inner vessel and the first and second side portions of the outer structure, the enclosed volume being evacuated to a pressure less than an external pressure.

2. The vacuum insulated container system of claim 1 wherein the outer structure has a polyhedron shape.

3. The vacuum insulated container system of claim 1 wherein the outer structure has a rectangular shape.

4. The vacuum insulated container system of claim 1 wherein the outer structure has a first polyhedron shape and the inner vessel has a second polyhedron shape, and wherein the second polyhedron shape is at least generally similar to the first polyhedron shape.

5. The vacuum insulated container system of claim 1 wherein the outer structure has a first rectangular shape, wherein the inner vessel has a second rectangular shape, and wherein the enclosed volume extends continuously around the periphery of the inner vessel.

6. The vacuum insulated container system of claim 1, further comprising an outlet device configured to dispense fluid from a bottom portion of the inner vessel.

7. The vacuum insulated container system of claim 1 wherein the inner vessel includes a third side portion extending upwardly from a sump portion, wherein the container system further comprises an outlet device configured to dispense fluid from the inner vessel, the outlet device extending through the first side portion of the outer structure and the third side portion of the inner vessel adjacent to the sump portion.

8. The vacuum insulated container system of claim 1, further comprising insulation material positioned between the outer structure and the inner vessel in at least a portion of the enclosed volume.

9. The vacuum insulated container system of claim 1 wherein at least the first side portion of the outer structure includes a stiffener.

10. The vacuum insulated container system of claim 1 wherein the inner vessel includes a third side portion that is at least generally flat, and wherein the third side portion includes at least one stiffener.

11. A vacuum insulated beverage container comprising:
an outer structure having a first side portion positioned adjacent to a second side portion, wherein the first side portion is at least approximately aligned with a first plane and the second side portion is at least approximately aligned with a second plane different than the first plane; and
a beverage-holding vessel positioned within the outer structure to define an enclosed volume therebetween, wherein the enclosed volume is at least partially evacuated.

12. The vacuum insulated beverage container of claim 11 wherein the outer structure has a polyhedron shape.

13. The vacuum insulated beverage container of claim 11 wherein the outer structure has a first rectangular shape and the beverage-holding vessel has a second rectangular shape.

14. The vacuum insulated beverage container of claim 11 wherein the outer structure has a first rectangular shape, wherein the beverage-holding vessel has a second rectangular shape, and wherein the enclosed volume extends at least approximately continuously around a periphery of the beverage-holding vessel.

15. The vacuum insulated beverage container of claim 11 wherein the outer structure includes a first inlet aperture having a first inlet flange, wherein the beverage-holding vessel includes a second inlet aperture having a second inlet flange, and wherein the first and second inlet flanges are fixedly attached to each other to at least partially seal the enclosed volume.

16. A vacuum insulated beverage dispenser comprising:
an outer structure having a first side portion positioned adjacent to a second side portion, wherein the first side portion is at least approximately aligned with a first plane and the second side portion is at least approximately aligned with a second plane different than the first plane;
an inner vessel positioned within the outer structure, the inner vessel having a third side portion offset from the first side portion to at least partially define a first evacuated region therebetween, the inner vessel further having a fourth side portion offset from the second side portion to at least partially define a second evacuated region therebetween; and
an open passage extending from the first evacuated region to the second evacuated region.

17. The vacuum insulated beverage dispenser of claim 16 wherein the open passage extends at least approximately from a bottom portion of the inner vessel to a top portion of the inner vessel.

18. The vacuum insulated beverage dispenser of claim 16 wherein the outer structure has a first polyhedron shape, wherein the inner vessel has a second polyhedron shape that is at least generally similar to the first polyhedron shape, and wherein the beverage dispenser further comprises an outlet device extending through the first side portion of the outer structure and the third side portion of the inner vessel, wherein the outlet device is configured to dispense beverage from the inner vessel.

19. A beverage dispenser, comprising:
an outer structure having at least a first side portion;
an inner vessel fixedly attached to the outer structure, the inner vessel having at least a second side portion extending upwardly from a sump portion, the sump portion being the lowest region of the inner vessel when the inner vessel is positioned in an upright orientation; and
an outlet device extending though the first side portion of the outer structure and the second side portion of the inner vessel adjacent to the sump portion, wherein the outlet device is user-operable to dispense beverage from the sump portion of the inner vessel.

20. The beverage dispenser of claim 19 wherein the inner vessel has a rectangular shape.

21. The beverage dispenser of claim 19 wherein the inner vessel has a cylindrical shape.

22. The beverage dispenser of claim 19, further comprising an evacuated region surrounding at least a portion of the inner vessel.

23. A vacuum insulated container system, comprising:
an outer structure having a first side portion positioned adjacent to a second side portion, the first side portion extending along a first plane and the second side portion extending along a second plane different than the first plane;
an inner vessel configured to carry fluid, the inner vessel being fixedly attached to the outer structure to define an enclosed volume extending at least between the inner vessel and the first and second side portions of the outer structure, the enclosed volume being evacuated to a pressure less than an external pressure;
means for introducing fluid into the inner vessel; and
means for dispensing fluid from the inner vessel.

24. The system of claim 23 wherein the means for dispensing fluid from the inner vessel include means for passing the fluid through an aperture in the first side portion of the outer structure.

25. The system of claim 23 wherein the inner vessel includes a third side portion offset from the first side portion of the outer structure, and wherein the means for dispensing fluid from the inner vessel include means for passing the fluid through a first aperture in the third side portion of the inner vessel and a second aperture in the first side portion of the outer structure.

26. A method for making a container system, comprising:
providing an outer structure having a first side portion positioned adjacent to a second side portion, the first side portion extending along a first plane and the second side portion extending along a second plane different than the first plane;
providing an inner vessel configured to carry fluid;
positioning the inner vessel within the outer structure;
fixedly attaching the inner vessel to the outer structure to define an enclosed volume extending at least between the inner vessel and the first and second side portions of the outer structure; and
at least partially evacuating the enclosed volume.

27. The method of claim 26 wherein fixedly attaching the inner vessel to the outer structure includes welding a first inlet flange of the inner vessel to a second inlet flange of the outer structure.

28. The method of claim 26, further comprising sealing the enclosed volume after evacuation by flowing a solder material over an evacuation aperture in the outer structure.

29. The method of claim 26, further comprising extending an outlet device through a first aperture in the first side portion of the outer structure and a second aperture in a third side portion of the inner vessel, wherein the outlet device is user-operable to dispense fluid from the inner vessel.
